(19) United States
(12) Patent Application Publication
(10) Pub. No.: US 2024/0028688 A1
(43) Pub. Date: Jan. 25, 2024

(54) UNLOCKING METHOD USING AUGMENTED REALITY

(71) Applicant: I-Ting Shen, Tainan (TW)

(72) Inventor: I-Ting Shen, Tainan (TW)

(21) Appl. No.: 17/892,274

(22) Filed: Aug. 22, 2022

(30) Foreign Application Priority Data
Jul. 22, 2022 (TW) 111127650

(51) Int. Cl. G06F 21/36; G06T 19/00

(52) U.S. Cl. CPC G06F 21/36; G06T 19/006

(57) ABSTRACT

An unlocking method using augmented reality includes projecting an augmented reality setting interface after an augmented reality device obtains an unlocking authority of a lock system. The augmented reality setting interface is used to set an unlocking information. The augmented reality device projects an augmented reality unlocking interface when a wearer of the augmented reality device intends to proceed with an unlocking operation of the lock system. The augmented reality unlocking interface is used to input a real-time unlocking information. The lock system is unlocked when the real-time unlocking information matches with the unlocking information.

### BACKGROUND OF THE INVENTION

The present invention relates to an unlocking method and, more particularly, to an unlocking method using augmented reality to unlock a lock system, such as a door lock.

With the progress of technology, electric locks, such as electric door locks, have become more and more popular. Furthermore, application of augmented reality, such as using augmented reality in vehicle navigation, is wider than ever. It is, therefore, worthy of proceeding research in the area of application of augmented reality in unlocking or related operations of electric locks.

### BRIEF SUMMARY OF THE INVENTION

The present invention provides an unlocking method using augmented reality. In an aspect, the unlocking method includes:
connecting an augmented reality device with a lock system to obtain an unlocking authority of the lock system;
using the augmented reality device to project an augmented reality setting interface;
using the augmented reality setting interface to input an unlocking information, saving the unlocking information, and closing the augmented reality setting interface;
identifying whether a wearer of the augmented reality setting device intends to proceed with an unlocking operation, wherein the augmented reality device projects an augmented reality unlocking interface when it is determined the wearer intends to proceed with the unlocking operation, and wherein the augmented reality device does not project the augmented reality unlocking interface when it is determined the wearer does not intend to proceed with the unlocking operation; and
using the augmented reality unlocking interface to input a real-time unlocking information, wherein the lock system remains locked when the real-time unlocking information is determined as correct or not inputted, and wherein the lock system proceeds with the unlocking operation when the real-time unlocking information is determined to be correct.

The projected unlocking interface according to the present invention cannot be seen by any person other than the wearer. Thus, stealthy of the real-time unlocking information is less likely to occur while the wearer is inputting the real-time unlocking information.

In an example, the augmented reality setting interface includes a plurality of icons representing numbers 0-9. The augmented reality setting interface identifies inputted numbers according to positions pointed by a finger of the wearer relative to the augmented reality setting interface.

In an example, the plurality of icons representing the numbers 0-9 is arranged in random.

The arrangement of the icons may be different every time the setting interface is projected. This reduces the possibility of stealthy of the real-time unlocking information during input.

In an example, the augmented reality unlocking interface includes a plurality of icons representing numbers 0-9. The augmented reality setting interface identities inputted numbers according to positions pointed by a finger of the wearer relative to the augmented reality unlocking interface.

In an example, the plurality of icons representing the numbers 0-9 is arranged in random every time the augmented reality unlocking interface is projected.

The arrangement of the icons is different every time the unlocking interface is projected. This reduces the possibility of stealthy of the real-time unlocking information during input.

In an example, when a distance between the augmented reality device and the lock system is not greater than 1 meter and when a camera of the augmented reality device detects presence of the lock system, the augmented reality device determines that the wearer intends to proceed with the unlocking operation. When the distance between the augmented reality device and the lock system is greater than 1 meter or when no presence of the lock system is detected by the camera, the augmented reality device determines that the wearer does not intend to proceed with the unlocking operation.

The distance between the lock system and the augmented reality device and detection of the presence of the lock system by the camera are used to identify whether the wearer intends to proceed with the unlocking operation, such that the augmented reality device can project the unlocking interface at the right time.

In another aspect, an unlocking method using augmented reality includes:
connecting an augmented reality device with a lock system to obtain an unlocking authority of the lock system;
using the augmented reality device to project an augmented reality setting interface;
using the augmented reality setting interface to input an unlocking information, saving the unlocking information, and closing the augmented reality setting interface;
using the augmented reality device to pick up a biological feature of a wearer of the augmented reality device before or after setting the unlocking authority, and setting the biological feature of the wearer as an authenticated identification information;
identifying whether the wearer of the augmented reality setting device intends to proceed with an unlocking operation, wherein the augmented reality device does not project an augmented reality unlocking interface when it is determined the wearer does not intend to proceed with the unlocking operation, wherein when it is determined the wearer intends to proceed with the unlocking operation, the augmented reality device picks up a real-time biological feature of the wearer, wherein the augmented reality device projects the augmented reality unlocking interface when the real-time biological feature matches with the authenticated identification information, and wherein the augmented reality device does not project the augmented reality unlocking interface when the real-time biological feature does not match with the authenticated identification information; and
using the augmented reality unlocking interface to input a real-time unlocking information, wherein the lock system remains locked when the real-time unlocking information is determined as correct or not inputted, and wherein the lock system proceeds with the unlocking operation when the real-time unlocking information is determined to be correct.

When it is intended to proceed with the unlocking operation, the augmented reality device will pick up the biological feature of the wearer to proceed with identity identification. Thus, even if the augmented reality device is lost, the person picking up the augmented reality device still cannot use the augmented reality device to proceed with the unlocking operation of the lock system whose unlocking authority is granted to the augmented reality device. The augmented reality device will not project the augmented reality unlocking interface. Therefore, the unlocking method of the second embodiment according to the present invention provides excellent safety.

In a further aspect, an unlocking method using augmented reality includes:
connecting a mobile device with a lock system to obtain an unlocking authority of the lock system;
using a setting interface displayed by a screen of the mobile device to input an unlocking information and saving the unlocking information;
connecting the mobile device with an augmented reality device;
using the augmented reality device to pick up a biological feature of a wearer of the augmented reality device, sending the biological feature to the mobile device, and setting the biological feature as an authenticated identification information;
identifying whether the wearer of the augmented reality setting device intends to proceed with an unlocking operation, wherein the augmented reality device does not project the augmented reality unlocking interface when it is determined the wearer does not intend to proceed with the unlocking operation, wherein when it is determined the wearer intends to proceed with the unlocking operation, the augmented reality device picks up a real-time biological feature of the wearer, wherein the augmented reality device projects an augmented reality unlocking interface when the real-time biological feature matches with the authenticated identification information, and wherein the augmented reality device does not project the augmented reality unlocking interface when the real-time biological feature does not match with the authenticated identification information; and
using the augmented reality unlocking interface to input a real-time unlocking information and sending the real-time unlocking information to the mobile device, wherein the lock system remains locked when the mobile device determines that the real-time unlocking information is correct, and wherein the mobile device controls the lock system to proceed with the unlocking operation when the mobile device determines that the real-time unlocking information is correct.

The unlocking operation can only be conducted only in the presence of the mobile device and the augmented reality device. When one of the mobile device and the augmented reality device is lost and the real-time unlocking information is known, a person picking up the mobile device or the augmented reality device still cannot proceed with the unlocking operation of the lock system, Thus, the third embodiment according to the present invention provides excellent safety.

The present invention will become clearer in light of the following detailed description of illustrative embodiments of this invention described in connection with the drawings.

### DESCRIPTION OF THE DRAWINGS

FIG. 1 is a flow chart illustrating a first embodiment of an unlocking method using augmented reality according to the present invention.

FIG. 2 is a flow chart illustrating a second embodiment of an unlocking method using augmented reality according to the present invention,

FIG. 3 is a flow chart illustrating a third embodiment of an unlocking method using augmented reality according to the present invention.

FIG. 4 is a diagrammatic view illustrating setting an unlocking information through use of an augmented reality setting interface according to the present invention.

FIG. 5 is a diagrammatic view illustrating input of an unlocking information through use of an augmented reality unlocking interface according to the present invention.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

The present invention provides an unlocking method using an augmented reality device to generate an augmented reality effect for cooperating with a lock system. The lock system can be, but not limited to, an electric lock controllable through electronic control measures. The augmented reality effect requires an augmented reality device worn on a person. The augmented reality device can be, but not limited to, eyeglasses (such as google glass or Mojo Lens) capable of generating an augmented reality effect.

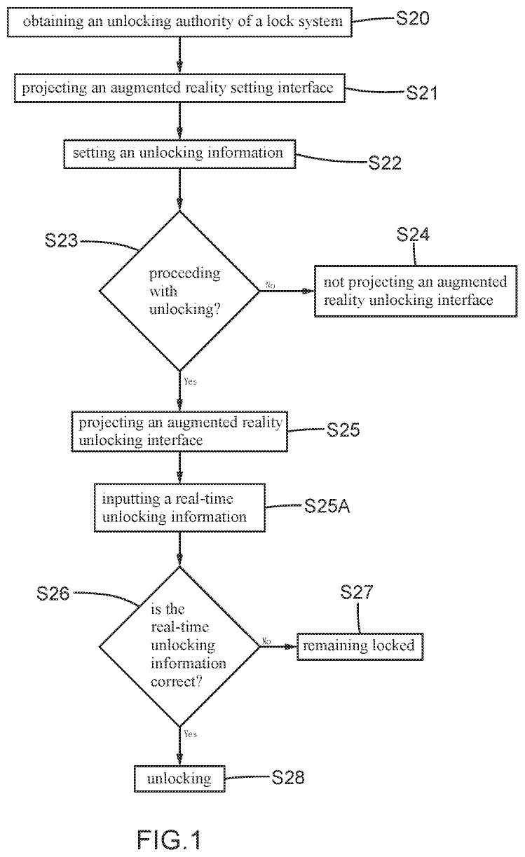

FIG. 1 shows a flow chart illustrating a first embodiment of an unlocking method using augmented reality according to the present invention. Firstly, an augmented reality device is connected with a lock system to obtain an unlocking authority of the lock system (step S20). Specifically, the augmented reality device and the lock system may use a wireless communication technology, such as Bluetooth, Wi-Fi, etc. to permit mutual communication. In a non-limiting example, a hardware identification code built-in the augmented reality device can be transmitted to the lock system after encryption or without encryption. The lock system sets the hardware identification code as an authorized hardware identification code, such that the augmented reality device obtains the unlocking authority of the lock system.

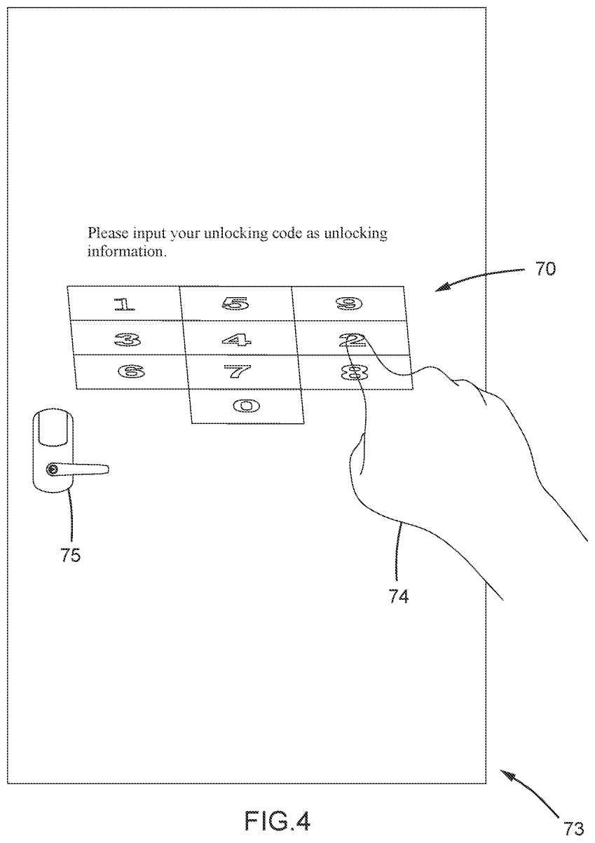

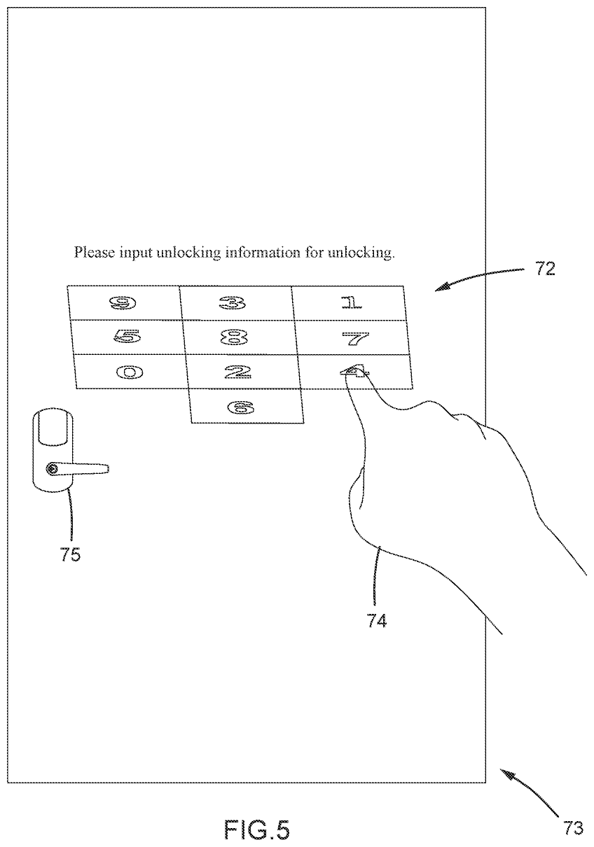

For example, assuming the lock system is an electric door lock 75 mounted on a door (see FIGS. 4 and 5), an authorization button is disposed inside the electric door lock 75 and will be revealed only after a housing of the electric door lock 75 is detached. When the authorization button is pressed, the hardware identification code sent from the augmented reality device can be set by the electric door lock 75 (connected to the augmented reality device) as the authorized hardware identification code, Namely, after the augmented reality device is connected with the electric door lock 75, the electric door lock 75 cannot set the hardware identification code of the augmented reality device as the authorized hardware identification code when the authorization button is not pressed. Furthermore, the housing of the electric door lock 75 cannot be easily detached. Specifically, the housing of the electric door lock 75 can only be detached from an indoor side. Thus, higher safety is attained when obtaining the unlocking authority of the lock system.

After the augmented reality device obtains the unlocking authority of the lock system, the augmented reality device projects an augmented device setting interface (hereinafter setting interface) 70 (step S21). Furthermore, after confirming that the augmented reality device has obtained the unlocking authority of the lock system, the augmented reality device automatically projects a setting interface.

With reference to FIG. 4, a wearer wearing the augmented reality device (hereinafter wearer) can see a reality 73 and a setting interface 70 overlapped with the reality 73. The setting interface 70 includes icons representing numerals and wordings “Please input your unlocking code as unlocking information”. The icons represent numerals 0-9 which can be arranged randomly or in any desired arrangement, such as from 0-9 in sequence or 1, 5, 9, 3, 4, 2, 6, 7, 8, 0, as shown in FIG. 4. Furthermore, the arrangement of the number icons can be different every time the setting interface is protected, providing higher confidentiality during setting of the unlocking information.

In a preferred example, the setting interface is not displayed on a screen, such as Google Glass. The augmented reality image is projected onto the retina of human eye by a transparent refraction device at a front side. At the same time, the wearer can observe the reality 73 by the light outside of the augmented reality device, which provides an effect that the human eye can simultaneously observe the reality 73 and the virtual setting interface 70. FIG. 4 shows a simulation of the augmented reality setting device 70 on a reality 73 comprised of a door and the electric door lock 75 mounted on the door.

The setting interface 70 displayed by the augmented reality device can be used to set an unlocking information (step S22). After the unlocking information is stored, the setting interface 70 is closed. Specifically, the augmented reality device can, but not limited to, use its camera to detect the position of the hand of the wearer. Through identification of the position of the hand, the augmented reality device permits input of an unlocking information by the function or under guidance of the setting interface 70.

For example, when the augmented reality device projects the setting interface 70 for the wearer, the augmented reality device detects the position pointed by the finger of the wearer relative to the setting interface 70 to identify the numbers inputted by the wearer. In an example, the unlocking information is a password comprised of a four-digit code, after the wearer inputs the password comprised of four digits (which can be repeated or not repeated), the augmented reality device outputs the password to the lock system which saves the password as an unlocking information. Alternatively, the password selected and inputted by the wearer can be saved by the augmented reality device and can be set as an unlocking information. The augmented reality device closes the setting interface 70 after the unlocking information is successfully set.

It is worth noting that the unlocking information is not limited to a password. In an example, the unlocking information may be a movement pattern of the hand of the wearer.

After setting an unlocking information, the augmented reality device detects whether the wearer intends to proceed with an unlocking operation (step S23). When the wearer does not intend to proceed with an unlocking operation, an augmented reality unlocking interface is not projected (step S24).

Specifically, the wearer does not always have the need to unlock the lock system. Thus, the augmented reality device must identify whether the wearer intends to proceed with the unlocking operation of the lock system whose unlocking authority is granted to the augmented reality device. In an example, whether the wearer intends to proceed with an unlocking operation of the lock system can be identified according to the distance between the augmented reality device and the lock system and determination of whether the lock system is located in the field of vision of the wearer through use of a camera. The distance between the augmented reality device and the lock system can, but not limited to, be calculated by the received signal strength indication (RSSI).

For example, assuming that the lock system is the electric door lock 75 mounted on the door, it is determined the wearer intends to proceed with the unlocking operation when the distance between the augmented reality device and the electric door lock 75 is not greater than 1 meter and when the camera of the augmented reality device detects the presence of the electric door lock 75 (the electric door lock 75 is in the field of vision). Specifically, in a case that the distance between the augmented reality device and the electric door lock 75 is greater than 1 meter, it is determined that the wearer does not intend to proceed with the unlocking operation regardless of the detection result of presence of the electric door lock 75 by the camera. Furthermore, it is determined that the wearer does not intend to proceed with the unlocking operation when the electric door lock 75 is not greater than 1 meter and when the electric door lock 75 is not detected by the camera. Thus, the augmented reality device does not project an unlocking interface 72 for the wearer (step S24).

On the other hand, when the wearer intends to proceed with the unlocking operation, the augmented reality device projects an augmented reality unlocking interface (hereinafter unlocking interface) 72 for the wearer (step S25).

In a case that the detected distance between the augmented reality device and the electric door Lock 75 is not greater than 1 meter and presence of the lock system (such as the electric door lock 75) is detected by the camera of the augmented reality device, the augmented reality device determines the wearer intends to proceed with the unlocking operation. Then, the augmented reality device projects the unlocking interface 72 for the wearer.

When the augmented reality device projects the unlocking interface 72 for the wearer, the wearer inputs a real-time unlocking information via the unlocking interface 72 (step S25A), Then, it is identified whether the real-time unlocking information is correct (step S26). When the real-time unlocking information is determined to be erroneous or not inputted, the lock system remains in a locked state (step S27). On the other hand, when the real-time unlocking information is determined to be correct, the lock system is unlocked (step S28).

The unlocking method of the first embodiment according to the present invention has been described. An example of use of the unlocking method using augmented reality of the first embodiment in connection with a scenario of use will be set forth to further assist in understanding of the technical features according to the present invention. It is assumed that the wearer wears an eyeglass-type augmented reality device (such as Google glass) including a camera and a Bluetooth communication function, and the lock system is an electric door lock 75 with a Bluetooth communication function.

With reference to FIG. 4, when the eyeglass type augmented reality device is within the Bluetooth communication range of the electric door lock 75 and the authorization button of the electric door lock 75 is pressed, the eyeglass-type augmented reality device is connected with the electric door lock 75. Then, the eyeglass-type augmented reality device projects a setting interface 70 including icons representing numbers 0-9 which can only be seen by the wearer wearing the eyeglass-type augmented reality device (hereinafter wearer). The wearer manually selects a four-digit password (“0798” in an example) as the to-be-set unlocking information. The message of the password “0798” is sent by the eyeglass-type augmented reality device to the electric door lock 75 via Bluetooth technology. Then, the electric door lock 75 sets the message as an unlocking information and sends a signal (indicative of success setting of the unlocking information) to the eyeglass-type augmented reality device. Next, the eyeglass-type augmented reality device closes the setting interface 72. Thereafter, the eyeglass-type augmented reality device can be used to proceed with unlocking operation of the electric door lock 75.

In a case that the wearer is at the outdoor side, when the distance between the eyeglass-type augmented reality device and the electric door lock 75 is greater than 1 meter (which is predetermined in this case), the eyeglass-type augmented reality device does not project the unlocking interface 72 even though the camera detects the presence of the electric door lock 75.

In the case that the wearer is at the outdoor side, when the distance between the eyeglass-type augmented reality device and the electric door lock 75 is not greater than the predetermined 1 meter, the eyeglass-type augmented reality device does not project the unlocking interface 72 when no presence of the electric door lock 75 is detected by the camera.

In the case that the wearer is at the outdoor side, when the distance between the eyeglass-type augmented reality device and the electric door lock 75 is not greater than the predetermined 1 meter and when the presence of the electric door lock 75 is detected by the camera, the eyeglass-type augmented reality device projects the unlocking interface 72 for the wearer.

In a case that the wearer is at the indoor side and the electric door lock 75 can be directly unlocked from the indoor side, the eyeglass-type augmented reality device will not project the unlocking interface 72 even though the distance between the eyeglass-type augmented reality device and the electric door lock 75 is smaller than 1 meter and the presence of the electric door lock 75 is detected by the camera. In an example, a part of the electric door lock 75 at the indoor side can include a shielding device for shielding or weakening the wireless signal of the electric door lock 75 at the indoor side. Thus, the eyeglass-type augmented reality device cannot identify whether the distance between the eyeglass-type augmented reality device and the electric door lock 75 is smaller than 1 meter. Therefore, the eyeglass-type augmented reality device will not project the unlocking interface 72 when the eyeglass-type augmented reality device is at the indoor side of the electric door lock 75.

With reference to FIG. 5, the wearer can use his or her hand 74 to input a real-time unlocking information according to the instruction on the unlocking interface 72. When the real-time unlocking information inputted by the wearer is “1234” (which is different from the preset unlocking information “0798”), the electric door lock 75 remains in the locked state, as the augmented reality device or the electric door lock 75 determines that the real-time unlocking information does not match with the preset unlocking information.

When the real-time unlocking information inputted by the wearer via the unlocking interface 72 is “0798”, the augmented reality device or the electric door lock determines that the real-time unlocking information matches with the preset unlocking information. Then, the electric door lock 75 is unlocked, and the wearer can open the door by operating the electric door lock 75.

It is worth noting that a single lock system (such as an electric lock) can correspond to a plurality of different augmented reality devices and can permit the augmented reality devices to set different unlocking informations, in this case, the unlocking information of each augmented reality device and the specific hardware identification code associated with the augmented reality device are sent to the lock system and set as the unlocking information. When a real-time unlocking information is inputted via, one of the augmented reality devices, the lock system can proceed with the unlocking operation only when the real-time unlocking information and the associated specific hardware identification code of the augmented reality device are correct. The lock system remains in the locked state when either of the real-time unlocking information and the hardware identification code is erroneous.

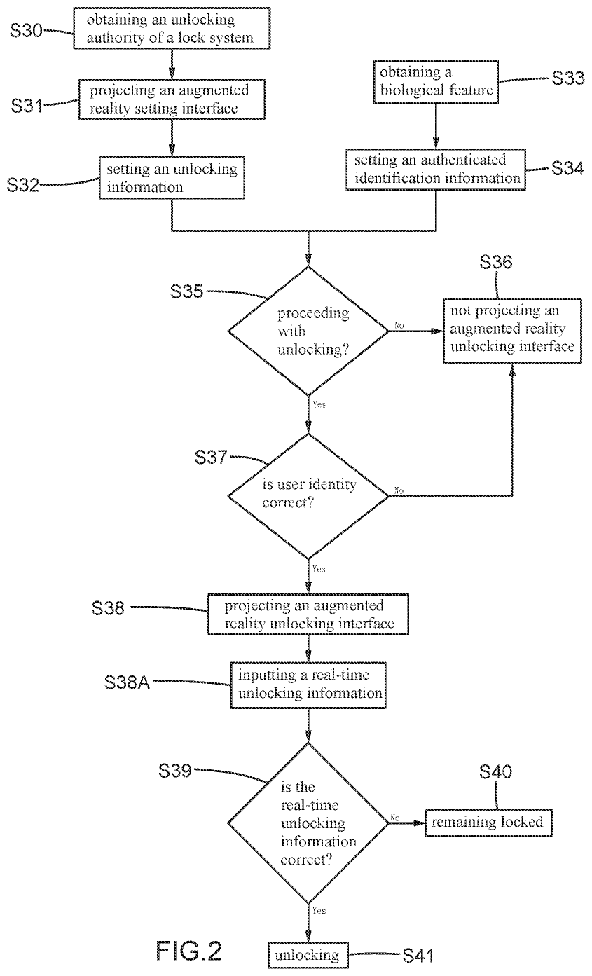

In addition to the first embodiment described in connection with FIG. 1, changes can be made within the scope of the present invention. FIG. 2 shows an unlocking method of a second embodiment according to the present invention. Firstly, an augmented reality device is connected with a lock system and obtains an unlocking authority of the lock system (step S30). Likewise, the augmented reality device and the lock system may be equipped with a wireless technology, such as Bluetooth. Wi-Fi, etc. for connection purposes. At the first time of use, the augmented reality device and the lock system are connected with each other by the wireless technology. In a non-limiting example, a hardware identification code built-in the augmented reality device is transmitted to the lock system with or without encryption. The lock system set the hardware identification code of the augmented reality device as an authorized hardware identification number, such that the augmented reality device obtains the unlocking authority of the mobile device.

For example, the lock system is an electric door lock 75 mounted on a door. The electric door lock 75 has an authorization button which will be revealed only when the electric door lock 75 is exposed. When the authorization button is pressed, the hardware identification code sent from the augmented reality device can be set by the electric door lock 75 (connected to the augmented reality device) as the authorized hardware identification code. Namely, after the augmented reality device is connected with the electric door lock 75, the electric door lock 75 cannot set the hardware identification code of the augmented reality device as the authorized hardware identification code when the authorization button is not pressed.

After the augmented reality device obtains the unlocking authority of the lock system, the augmented reality device projects an augmented device setting interface (hereinafter setting interface) (step S31), Specifically, since the augmented reality device is connected with the lock system while the authorization button is pressed, after confirming that the augmented reality device has obtained the unlocking authority of the lock system, the augmented reality device automatically projects a setting interface. The augmented reality setting interface of the second embodiment is substantially the same as that of the first embodiment and is, therefore, not further described in avoid redundancy.

The setting interface 70 displayed by the augmented reality device can be used to set an unlocking information (step S32). After the unlocking information is stored, the setting interface 70 is closed. Specifically, the augmented reality device can, but not limited to, use its camera to detect the position of the hand of the wearer. Through identification of the position of the hand, the augmented reality device permits input of an unlocking information by the function or under guidance of the setting interface 70.

For example, when the augmented reality device projects the setting interface 70 for the wearer, the augmented reality device detects the position pointed by the finger of the wearer relative to the setting interface 70 to identify the numbers inputted by the wearer. In an example, the unlocking information is a password comprised of a four-digit code, after the wearer inputs the password comprised of four digits (which can be repeated or not repeated), the augmented reality device outputs the password to the lock system which saves the password as an unlocking information. Alternatively, the password selected and inputted by the wearer can be saved by the augmented reality device and can be set as an unlocking information. The augmented reality device closes the setting interface 70 after the unlocking information is set.

It is worth noting that the unlocking information is not limited to a password. In an example, the unlocking information may be a movement pattern of the hand of the wearer.

After or before setting of the unlocking information, the augmented reality device picks up a biological feature of the wearer (step S33). As an example, the augmented reality device is eyeglass-type or contact-lens type, and the augmented reality device picks up the image of the iris (the biological feature) of the wearer.

After obtaining the biological feature, the wearer can set the biological feature as an authenticated identification information (step S34). In an example, the iris feature picked up by the eyeglass-type augmented reality device is saved by the augmented reality device and set as the authenticated identification information.

After setting of the unlocking information and the authenticated identification information, the augmented reality device detects whether the wearer intends to proceed with an unlocking operation (step S35). When the wearer does not intend to proceed with an unlocking operation, an augmented reality unlocking interface is not projected (step S36).

Specifically, the wearer does not always have the need to unlock the lock system. Thus, the augmented reality device must identify whether the wearer intends to proceed with the unlocking operation of the lock system whose unlocking authority is granted to the augmented reality device. In an example, whether the wearer intends to proceed with an unlocking operation of the lock system carr be identified according to the distance between the augmented reality device and the lock system and determination of whether the lock system is located in the field of vision of the wearer through use of a camera. The distance between the augmented reality device and the lock system can, but not limited to, be calculated by the received signal strength indication (RSSI).

For example, assuming that the lock system is the electric door lock 75 mounted on the door, it is determined the wearer intends to proceed with the unlocking operation when the distance between the augmented reality device and the electric door lock 75 is not greater than 1 meter and when the camera of the augmented reality device detects the presence of the electric door lock 75 (the electric door lock 75 is in the field of vision). In a case that the distance between the augmented reality device and the electric door lock 75 is greater than 1 meter or the camera detects no presence of the electric door lock 75, it is determined that the wearer does not intend to proceed with the unlocking operation. Thus, the augmented reality device does not project an unlocking interface 72 for the wearer (step S36).

Similar to the first embodiment, in the second embodiment, when the wearer is at the indoor side, the eyeglass-type augmented reality device will not project the unlocking interface 72 even though the distance between the eyeglass-type augmented reality device and the electric door lock 75 is smaller than 1 meter and the presence of the electric door lock 75 is detected by the camera. The effect of the technical features achieved by the second embodiment is the same as that of the first embodiment and is, therefore, not further described to avoid redundancy.

When the wearer is at the outdoor side and intends to proceed with an unlocking operation, the augmented reality device picks up a real-time biological feature for identity identification (step S37). When it is determined that the real-time biological feature does not match with the authenticated identification information, the augmented reality device does not project the unlocking interface (S36). On the other hand, when it is determined that the real-time biological feature matches with the authenticated identification information, the augmented reality device projects the unlocking interface (S36).

It is determined that the wearer does not intend to proceed with the unlocking operation when: (1) the distance between the augmented reality device and the lock system is smaller than 1 meter and no presence of the lock system is detected by the camera of the augmented reality device, (2) the distance between the augmented reality device and the lock system is greater than 1 meter and the camera detects the presence of the lock system, or (3) the distance between the augmented reality device and the lock system is greater than 1 meter and no presence of the lock system is detected by the camera. Thus, the augmented reality device will not pick up the iris feature of the wearer, and the augmented reality device does not project an unlocking interface 72 for the wearer.

Furthermore, it is determined that the wearer intends to proceed with the unlocking operation when the distance between the augmented reality device and the electric door lock 75 is smaller than 1 meter and the presence of the electric door lock 75 is detected by the camera. The augmented reality device automatically picks up the iris feature (the real-time biological feature) of the wearer and compares the picked-up iris feature with the authenticated identification information. When the real-time biological feature matches with the authenticated identification information, the augmented reality device projects the unlocking interface 72 for the wearer.

When the augmented reality device projects the unlocking interface 72 for the wearer, the wearer inputs a real-time unlocking information via the unlocking interface 72 (step S38A). Then, it is identified whether the real-time unlocking information is correct (step S39). When the real-time unlocking information is determined to be erroneous or not inputted, the lock system remains in a locked state (step S40). On the other hand, when the real-time unlocking information is determined to be correct, the lock system is unlocked (step S41).

The unlocking method of the second embodiment according to the present invention has been described. An example of use of the unlocking method using augmented reality of the second embodiment in connection with a scenario of use will be set forth to further assist in understanding of the technical features according to the present invention. It is assumed that the wearer wears an eyeglass-type augmented reality device (such as Google glass) including a camera and a Bluetooth communication function, and the lock system is an electric door lock 75 with a Bluetooth communication function.

With reference to FIG. 4, when the eyeglass type augmented reality device is within the Bluetooth communication range of the electric door lock 75 and the authorization button of the electric door lock 75 is pressed, the eyeglass-type augmented reality device is connected with the electric door lock 75. Then, the eyeglass-type augmented reality device projects a setting interface 70 including icons representing numbers 0-9 which can only be seen by the wearer wearing the eyeglass-type augmented reality device (hereinafter wearer). The wearer manually selects a four-digit password (“5231” in an example) as the to-be-set unlocking information. The message of the password “5231” is sent by the eyeglass-type augmented reality device to the electric door lock 75 via Bluetooth technology. Then, the electric door lock 75 sets the password as an unlocking information and sends a signal (indicative of success setting of the unlocking information) to the eyeglass-type augmented reality device. Next, the eyeglass-type augmented reality device closes the setting interface 72. Thereafter, the eyeglass-type augmented reality device can be used to proceed with unlocking operation of the electric door lock 75.

After setting of the unlocking information, the eyeglass-type augmented reality device automatically picks up the iris feature (biological feature) of the wearer. The iris feature is saved as an authenticated identification information.

In a case that the wearer is at the outdoor side, when the distance between the eyeglass-type augmented reality device and the electric door lock 75 is greater than the preset 1 meter, even though the presence of the electric door lock 75 is detected by the camera, the eyeglass-type augmented reality device will not pick up the iris feature of the wearer and will not project the unlocking interface 72.

In a case that the wearer is at the outdoor side, when the distance between the eyeglass-type augmented reality device and the electric door lock 75 is not greater than the preset 1 meter and no presence of the electric door lock 75 is detected by the camera, the eyeglass-type augmented reality device will not pick up the iris feature of the wearer and will not project the unlocking interface 72.

In a case that the wearer is at the outdoor side, when the distance between the eyeglass-type augmented reality device and the electric door lock 75 is not greater than the preset 1 meter and the presence of the electric door lock 75 is detected by the camera, the eyeglass-type augmented reality device will pick up the iris feature of the wearer. When the real-time biological feature (the iris feature) does not match with the authenticated identification information, the augmented reality device does not project the unlocking interface 72. On the other hand, when the real-time biological feature (the iris feature) matches with the authenticated identification information, the augmented reality device projects the unlocking interface 72.

With reference to FIG. 5, the wearer can use his or her hand 74 to input a real-time unlocking information according to the instruction on the unlocking interface 72. When the real-time unlocking information inputted by the wearer is “1234” (which is different from the preset unlocking information “5231”), the electric door lock 75 remains in the locked state, as the augmented reality device or the electric door lock 75 determines that the real-time unlocking information does not match with the preset unlocking information.

When the real-time unlocking information inputted by the wearer via the unlocking interface 72 is “5231”, the augmented reality device or the electric door lock determines that the real-time unlocking information matches with the preset unlocking information. Thus, the electric door lock 75 is unlocked, and the wearer can open the door by operating the electric door lock 75.

In the unlocking method of the second embodiment according to the present invention, when it is intended to proceed with the unlocking operation, the augmented reality device will pick up the biological feature of the wearer to proceed with identity identification. Thus, even if the augmented reality device is lost, the person picking up the augmented reality device still cannot use the augmented reality device to proceed with the unlocking operation of the lock system whose unlocking authority is granted to the augmented reality device. The augmented reality device will not project the augmented reality unlocking interface. Therefore, the unlocking method of the second embodiment according to the present invention provides excellent safety.

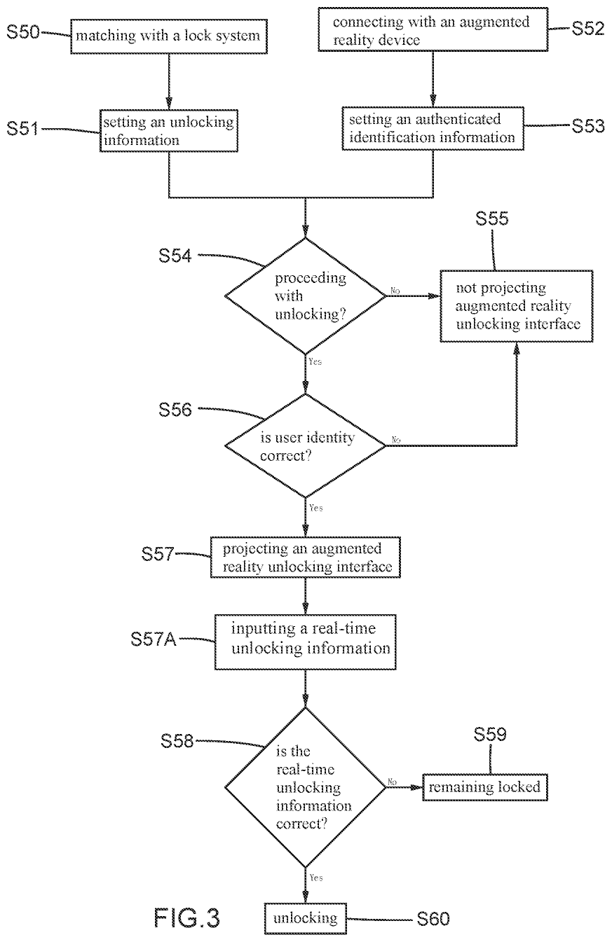

FIG. 3 shows an unlocking method of a third embodiment according to the present invention. The unlocking method of the third embodiment includes using the augmented reality device to cooperate with a mobile device and a lock system. Firstly, the mobile device is connected with the lock system to obtain an unlocking authority of the lock system (step S50). The mobile device, the augmented reality device, and the lock system are equipped with a wireless technology, such as Bluetooth, Wi-Fi, etc. At the first time of use, the mobile device and the lock system are connected with each other by the wireless technology, in a non-limiting example, a hardware identification code built-in the mobile device is transmitted to the lock system with or without encryption. The lock system set the hardware identification code of the mobile device as an authorized hardware identification code, such that the mobile device obtains the unlocking authority of the mobile device.

For example, the lock system is an electric door lock 75 mounted on a door. The electric door lock 75 has an authorization button which will be revealed only when the electric door lock 75 is exposed. When the authorization button is pressed, the hardware identification code sent from the mobile device can be set by the electric door lock 75 (connected to the mobile device) as the authorized hardware identification code. Namely, after the mobile device is connected with the electric door lock 75, the electric door lock 75 cannot set the hardware identification code of the mobile device as the authorized hardware identification code when the authorization button is not pressed.

After matching the mobile device with the lock system, a setting interface is displayed on a screen of the mobile device and can be used to set an unlocking information which is saved (step S51: setting an unlocking information). Specifically, the mobile device can, but not limited to, display the setting interface on a touch screen. The mobile device can identify the position pointed by the hand of the owner of the mobile device to detect the unlocking information inputted via the touch screen.

For example, after the setting interface is displayed on the touch screen of the mobile device, the owner of the mobile device can select a password through use of the setting interface. In an example that the unlocking information is a four-digit password, the owner of the mobile device can select a password consisted of four digits which can be repeated or not repeated. After the owner of the mobile device inputs the selected password, the mobile device sends the password to the lock system which sets the password as an unlocking information. Alternatively, after the owner of the mobile device inputs the selected password, the mobile device saves the password and sets the password as an unlocking information. After the unlocking information is successfully set, the mobile device closes the setting interface.

It is worth noting that the unlocking information is not limited to a password. In an example, the unlocking information may be a movement pattern of the hand of the wearer.

After setting the unlocking information, the mobile device is connected with an augmented reality device (step S52). The connection between the mobile device and the augmented reality device can be established by Bluetooth technology.

After the mobile device is connected with the augmented reality device, the augmented reality device picks up a biological feature of the wearer. The biological feature is sent to the mobile device and set as an authenticated identification information (step S53). Specifically, after first connection between the mobile device and the augmented reality device is established, the augmented reality device automatically picks up the biological feature (such as iris) of the wearer, and the picked-up biological feature is sent to the mobile device connected with the augmented reality device. Next, the mobile device sets the biological feature as an authenticated identification information.

After setting the unlocking information and the authenticated identification information, the augmented reality device detects whether the wearer intends to proceed with an unlocking operation (step S54). When the wearer does not intend to proceed with an unlocking operation, an augmented reality unlocking interface is not projected (step S55).

Specifically, the wearer does not always have the need to unlock the lock system. Thus, the augmented reality device must identify whether the wearer proceeds with the unlocking operation of the lock system whose unlocking authority is granted to the augmented reality device. In an example, whether the wearer intends to proceed with an unlocking operation of the lock system can be identified according to the distance between the augmented reality device and the lock system and determination of whether the lock system is located in the field of vision of the wearer through use of a camera. The distance between the augmented reality device and the lock system can, but not limited to, be calculated by the received signal strength indication (RSSI).

For example, assuming that the lock system is an electric door lock 75 mounted on the door, it is determined the wearer intends to proceed with the unlocking operation when the distance between the augmented reality device and the electric door lock 75 is not greater than 1 meter and when the camera of the augmented reality device detects the electric door lock 75 (the electric door lock 75 is in the field of vision). In a case that the distance between the augmented reality device and the electric door lock 75 is greater than 1 meter or no presence of the electric door lock 75 is not detected by the camera, it is determined that the wearer does not intend to proceed with the unlocking operation. Thus, the augmented reality device does not project an unlocking interface 72 for the wearer (step S55).

When the wearer is at the outdoor side and intends to proceed with an unlocking operation, the augmented reality device picks up a real-time biological feature for identify identification (step S56). When it is determined that the real-time biological feature does not match with the authenticated identification information, the augmented reality device does not project the unlocking interface (S55). On the other hand, when it is determined that the real-time biological feature matches with the authenticated identification information, the augmented reality device projects the unlocking interface (S57).

It is determined that the wearer intends to proceed with the unlocking operation when the distance between the augmented reality device and the lock system is smaller than 1 meter and when the presence of the lock system is detected by the camera. The augmented reality device projects the unlocking interface 72 for the wearer.

When the augmented reality device projects the unlocking interface 72 for the wearer, the wearer inputs a real-time unlocking information via the unlocking interface 72 (step S57A), and the real-time unlocking information is sent back to the mobile device. The mobile device receives and identifies whether the real-time unlocking information from the augmented reality device is correct (step S58). When the mobile device determines that the real-time unlocking information is erroneous, the lock system remains in a locked state (step S59). On the other hand, when the real-time unlocking information is determined to be correct, the lock system is unlocked (step S60).

The unlocking method of the third embodiment according to the present invention has been described. An example of use of the unlocking method using augmented reality of the third embodiment in connection with a scenario of use will be set forth to further assist in understanding of the technical features according to the present invention. It is assumed that the wearer wears an eyeglass-type augmented reality device (such as Google glass) including a camera and a Bluetooth communication function, the lock system is an electric door lock 75 with a Bluetooth communication function, and the mobile device is a smart phone with a Bluetooth communication function.

When the smart phone is within the Bluetooth communication range of the electric door lock 75 and the authorization button of the electric door lock 75 is pressed, the owner of the smart phone can use a touch screen of the smart phone (which shows a setting interface 70 including icons representing numbers 0-9) to input the unlocking information. As an example, the owner of the smart phone selects and manually input a four-digit password “9963” as the to-be-set unlocking information. The message of the password “9963” is sent by the smart phone to the electric door lock 75 via. Bluetooth technology. Then, the electric door lock 75 sets the number message “9963” as an unlocking information and sends a signal (indicative of success setting of the unlocking information) to the smart phone Next, the smart phone closes the setting interface 72.

Next, the smart phone and the eyeglass-type augmented reality device within the Bluetooth intercommunication range are connected via Bluetooth technology. After connection of the smart phone and the eyeglass-type augmented reality device, the eyeglass-type augmented reality device picks up the iris feature (the biological feature) of the wearer, and the iris feature is sent to the smart phone. The smart phone sets the iris feature as an authenticated identification information.

In a case that the wearer is at the outdoor side, when the distance between the eyeglass-type augmented reality device and the electric door lock 75 is greater than the pre-set 1 meter, the eyeglass-type augmented reality device will not project the setting interface 72 even if the electric door lock 75 is detected by the camera.

In a case that the wearer is at the outdoor side, when the distance between the eyeglass-type augmented reality device and the electric door lock 75 is not greater than the pre-set 1 meter and when no presence of the electric door lock 75 is detected by the camera, the eyeglass-type augmented reality device will not project the unlocking interface 72.

In a case that the wearer is at the outdoor side, when the distance between the eyeglass-type augmented reality device and the electric door lock 75 is not greater than the pre-set 1 meter and when the presence of the electric door lock 75 is detected by the camera, the eyeglass-type augmented reality device determines that the wearer intends to proceed with the unlocking operation. Next, the eyeglass-type augmented reality device automatically picks up the iris feature (the biological feature) of the wearer and sends the iris feature to the smart phone which identifies whether the iris feature matches with the authenticated identification information. When the iris feature does not match with the authenticated identification information, the eyeglass-type augmented reality device does not project the unlocking interface 72 for the wearer. On the other hand. When the iris feature matches with the authenticated identification information, the eyeglass-type augmented reality device projects the unlocking interface 72 for the wearer.

With reference to FIG. 5, the wearer can use his or her hand 74 to input a real-time unlocking information according to the instruction on the unlocking interface 72. The eyeglass-type augmented reality device sends the real-time unlocking information to the smart phone by the Bluetooth technology. The smart phone identifies whether the received real-time unlocking information from eyeglass-type augmented reality device matches with the unlocking information preset in the smart phone. For example, when the real-time unlocking information inputted by the wearer is “1234” (which is different from the preset unlocking information “9963”), the eyeglass-type augmented reality device sends the real-time unlocking information (“1234”) to the smart phone. Since the real-time unlocking information does not match with the preset unlocking information, the smart phone does not control the electric door lock 75 to proceed with the unlocking operation, such that the electric door lock 75 remains in the locked state.

When the real-time unlocking information inputted by the wearer via the unlocking interface 72 is “9963”, the augmented reality device sends the real-time unlocking information “9963” to the smart phone. The smart phone determines that the real-time unlocking information matches with the preset unlocking information, such that the smart phone controls the electric door lock 75 to proceed with the unlocking operation, and the wearer can open the door by operating the electric door lock 75.

In the unlocking method of the third embodiment according to the present invention, the unlocking operation can only be conducted only in the presence of the mobile device and the augmented reality device. When one of the mobile device and the augmented reality device is lost and the real-time unlocking information is known, a person picking up the mobile device or the augmented reality device still cannot proceed with the unlocking operation of the lock system. Thus, the third embodiment according to the present invention provides excellent safety.

Furthermore, in the unlocking method of the third embodiment according to the present invention, since identification of all of the lock system, identity, and the real-time unlocking information are carried out by the mobile device (such as a smart phone), the augmented reality device may include low-end hardware, such that the costs and weight of the augmented reality device can be effectively reduced.

The projected unlocking interface 72 of each embodiment according to the present invention cannot be seen by any person other than the wearer, Thus, stealthy of the real-time unlocking information is less likely to occur while the wearer is inputting the real-time unlocking information.

In each embodiment, the arrangement of the icons is different every time the unlocking interface 72 is projected. This reduces the possibility of stealthy of the real-time unlocking information during input.

In each embodiment, the distance between the lock system and the augmented reality device and detection of the presence of the lock system by the camera are used to identify whether the wearer intends to proceed with the unlocking operation, such that the augmented reality device can project the unlocking interface at the right time.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An unlocking method using augmented reality, with the unlocking method comprising:
connecting an augmented reality device with a lock system to obtain an unlocking authority of the lock system;
using the augmented reality device to project an augmented reality setting interface;
using the augmented reality setting interface to input an unlocking information, saving the unlocking information, and closing the augmented reality setting interface;
identifying whether a wearer of the augmented reality setting device intends to proceed with an unlocking operation, wherein the augmented reality device projects an augmented reality unlocking interface when it is determined the wearer intends to proceed with the unlocking operation, and wherein the augmented reality device does not project the augmented reality unlocking interface when it is determined the wearer does not intend to proceed with the unlocking operation; and
using the augmented reality unlocking interface to input a real-time unlocking information, wherein the lock system remains locked when the real-time unlocking information is determined as correct or not inputted, and wherein the lock system proceeds with the unlocking operation when the real-time unlocking information is determined to be correct.

2. The unlocking method as claimed in claim 1, wherein the augmented reality setting interface includes a plurality of icons representing numbers 0-9, and wherein the augmented reality setting interface identities inputted numbers according to positions pointed by a finger of the wearer relative to the augmented reality setting interface.

3. The unlocking method as claimed in claim 2, wherein the plurality of icons representing the numbers 0-9 is arranged in random.

4. The unlocking method as claimed in claim 1, wherein the augmented reality unlocking interface includes a plurality of icons representing numbers 0-9, and wherein the augmented reality setting interface identities inputted numbers according to positions pointed by a finger of the wearer relative to the augmented reality unlocking interface.

5. The unlocking method as claimed in claim 4, wherein the plurality of icons representing the numbers 0-9 is arranged in random every time the augmented reality unlocking interface is projected.

6. The unlocking method as claimed in claim 1, wherein when a distance between the augmented reality device and the lock system is not greater than 1 meter and when a camera of the augmented reality device detects presence of the lock system, the augmented reality device determines that the wearer intends to proceed with the unlocking operation, and wherein when the distance between the augmented reality device and the lock system is greater than 1 meter or when no presence of the lock system is detected by the camera, the augmented reality device determines that the wearer does not intend to proceed with the unlocking operation.

7. An unlocking method using augmented reality, with the unlocking method comprising:
connecting an augmented reality device with a lock system to obtain an unlocking authority of the lock system;
using the augmented reality device to project an augmented reality setting interface;
using the augmented reality setting interface to input an unlocking information, saving the unlocking information, and closing the augmented reality setting interface;
using the augmented reality device to pick up a biological feature of a wearer of the augmented reality device before or after setting the unlocking authority, and setting the biological feature of the wearer as an authenticated identification information;
identifying whether the wearer of the augmented reality selling device intends to proceed with an unlocking operation, wherein the augmented reality device does not project an augmented reality unlocking interface when it is determined the wearer does not intend to proceed with the unlocking operation, wherein when it is determined the wearer intends to proceed with the unlocking operation, the augmented reality device picks up a real-time biological feature of the wearer, wherein the augmented reality device projects the augmented reality unlocking interface when the real-time biological feature matches with the authenticated identification information, and wherein the augmented reality device does not project the augmented reality unlocking interface when the real-time biological feature does not match with the authenticated identification information; and
using the augmented reality unlocking interface to input a real-time unlocking information, wherein the lock system remains locked when the real-time unlocking information is determined as correct or not inputted, and wherein the lock system proceeds with the unlocking operation when the real-time unlocking information is determined to be correct.

8. The unlocking method as claimed in claim 7, wherein both the biological feature and the real-time biological feature are an iris feature of the wearer.

9. The unlocking method as claimed in claim 7, wherein the augmented reality setting interface includes a plurality of icons representing numbers 0-9, and wherein the augmented reality setting interface identifies inputted numbers according to positions pointed by a finger of the wearer relative to the augmented reality setting interface.

10. The unlocking method as claimed in claim 9, wherein the plurality of icons representing the numbers 0-9 is arranged in random.

11. The unlocking method as claimed in claim 7, wherein the augmented reality unlocking interface includes a plurality of icons representing numbers 0-9, and wherein the augmented reality setting interface identifies inputted numbers according to positions pointed by a finger of the wearer relative to the augmented reality unlocking interface.

12. The unlocking method as claimed in claim 11, wherein the plurality of icons representing the numbers 0-9 is arranged in random every time the augmented reality unlocking interface is projected.

13. The unlocking method as claimed in claim 7, wherein when a distance between the augmented reality device and the lock system is not greater than 1 meter and when a camera of the augmented reality device detects presence of the lock system, the augmented reality device determines that the wearer intends to proceed with the unlocking operation, and wherein when the distance between the augmented reality device and the lock system is greater than 1 meter or when no presence of the lock system is detected by the camera, the augmented reality device determines that the wearer does not intend to proceed with the unlocking operation.

14. An unlocking method using augmented reality, with the unlocking method comprising:
connecting a mobile device with a lock system to obtain an unlocking authority of the lock system;
using a setting interface displayed by a screen of the mobile device to input an unlocking information and saving the unlocking information;
connecting the mobile device with an augmented reality device;
using the augmented reality device to pick up a biological feature of a wearer of the augmented reality device, sending the biological feature to the mobile device, and setting the biological feature as an authenticated identification information;
identifying whether the wearer of the augmented reality selling device intends to proceed with an unlocking operation, wherein the augmented reality device does not project the augmented reality unlocking interface when it is determined the wearer does not intend to proceed with the unlocking operation, wherein when it is determined the wearer intends to proceed with the unlocking operation, the augmented reality device picks up a real-time biological feature of the wearer, wherein the augmented reality device projects an augmented reality unlocking interface when the real-time biological feature matches with the authenticated identification information, and wherein the augmented reality device does not project the augmented reality unlocking interface when the real-time biological feature does not match with the authenticated identification information; and
using the augmented reality unlocking interface to input a real-time unlocking information and sending the real-time unlocking information to the mobile device, wherein the lock system remains locked when the mobile device determines that the real-time unlocking information is correct, and wherein the mobile device controls the lock system to proceed with the unlocking operation when the mobile device determines that the real-time unlocking information is correct.

15. The unlocking method as claimed in claim 14, wherein both the biological feature and the real-time biological feature are an iris feature of the wearer.

16. The unlocking method as claimed in claim 14, wherein the augmented reality unlocking interface includes a plurality of icons representing numbers 0-9, and wherein the augmented reality setting interface identifies inputted numbers according to positions pointed by a finger of the wearer relative to the augmented reality unlocking interface.

17. The unlocking method as claimed in claim 14, wherein the plurality of icons representing the numbers 0-9 is arranged in random every time the augmented reality unlocking interface is projected.

18. The unlocking method as claimed in claim 14, wherein when a distance between the augmented reality device and the lock system is not greater than 1 meter and when a camera of the augmented reality device detects presence of the lock system, the augmented reality device or the mobile device determines that the wearer intends to proceed with the unlocking operation, and wherein when the distance between the augmented reality device and the lock system is greater than 1 meter or when no presence of the lock system is detected by the camera, the augmented reality device or the mobile device determines that the wearer does not intend to proceed with the unlocking operation.
